(19) United States
(12) Patent Application Publication
(10) Pub. No.: US 2025/0087699 A1
(43) Pub. Date: Mar. 13, 2025

(54) ALL-SOLID-STATE BATTERY

(71) Applicant: LG ENERGY SOLUTION, LTD., Seoul (KR)

(72) Inventor: Guilong JIN, Daejeon (KR)

(21) Appl. No.: 18/288,992

(22) PCT Filed: Apr. 12, 2023
(86) PCT No.: PCT/KR2023/004911

§ 371 Date: Oct. 30, 2023

(30) Foreign Application Priority Data
May 9, 2022 (KR) 10-2022-0056342
Apr. 7, 2023 (KR) 10-2023-0046259

(51) Int. Cl. H01M 4/62; H01M 4/02; H01M 4/36; H01M 10/0562

(52) U.S. Cl. CPC H01M 4/628; H01M 4/366; H01M 10/0562; H01M 2004/027; H01M 2300/008

(57) ABSTRACT

An all-solid-state battery is provided. The all-solid-state battery comprises a positive electrode, a negative electrode and a solid electrolyte membrane between the positive electrode and the negative electrode, and further comprises a first composite carbon layer and a second composite carbon layer between the negative electrode and the solid electrolyte membrane.

### CROSS-REFERENCE TO RELATED APPLICATION

This application is a US national phase of international application No. PCT/KR2023/004911 filed on Apr. 12, 2023, and claims the benefits of priorities based on Korean Patent Application No. 10-2022-0056342 filed on May 9, 2022 and Korean Patent Application No. 10-2023-0046259 filed on Apr. 7, 2023, the disclosures of which are incorporated herein by reference in their entireties.

### FIELD OF DISCLOSURE

The present disclosure relates to an all-solid-state battery, and more particularly, to an all-solid-state battery with improved lifetime characteristics by including a plurality of composite carbon layers between a solid electrolyte membrane and a negative electrode.

### BACKGROUND

The importance of lithium secondary batteries is increasing due to the increase in the use of vehicles, computers, and portable terminals. Among them, the development of lithium secondary batteries capable of obtaining high energy density with a light weight is particularly required. These lithium secondary batteries may be manufactured by inserting a separator between a positive electrode and a negative electrode and then injecting liquid electrolyte to manufacture a lithium-ion battery, or by interposing a solid electrolyte membrane between a positive electrode and a negative electrode to manufacture an all-solid-state battery.

Among them, a lithium-ion battery using a liquid electrolyte has a structure in which a negative electrode and a positive electrode are partitioned by a separator, and thus if the separator is damaged due to deformation or external impact, a short circuit may occur, which may lead to dangers such as overheating or explosion.

On the other hand, an all-solid-state battery using a solid electrolyte increases the safety of the battery and can prevent leakage of the electrolyte solution, thereby improving the reliability of the battery. However, such an all-solid-state battery has a problem in that a short circuit occurs in the cell due to lithium dendrite generated on the lithium metal negative electrode when charging and discharging are repeated.

### SUMMARY

One of objectives of the present disclosure is to provide an all-solid-state battery having an improved lifetime characteristics by incorporating composite carbon layers with different contents of binder between a solid electrolyte membrane and a negative electrode to induce a difference in electrical conductivity therebetween, and thereby allowing lithium to precipitate in the plane direction between the composite carbon layers due to the resulting difference in voltage.

One example of the present disclosure provides an all-solid-state battery comprising a positive electrode, a negative electrode and a solid electrolyte membrane between the positive electrode and the negative electrode, and further comprising a first composite carbon layer and a second composite carbon layer between the negative electrode and the solid electrolyte membrane.

The first composite carbon layer may be disposed adjacent to one surface of the solid electrolyte membrane, and the second composite carbon layer may be disposed adjacent to one surface of the negative electrode.

Each of the first composite carbon layer and the second composite carbon layer may include a carbon material and a binder, and the contents of binder in the first composite carbon layer and the second composite carbon layer may be different from each other.

A weight ratio of the carbon material to the binder in the first composite carbon layer may be 80:20 to 95:5, and a weight ratio of the carbon material to the binder in the second composite carbon layer may be 95:5 to 99:1.

A thickness ratio of the first composite carbon layer to the second composite carbon layer may be 20:1 to 1:1.

A thickness of the first composite carbon layer may be 5 to 20 μm, and a thickness of the second composite carbon layer may be 1 to 5 μm.

The solid electrolyte membrane may include one selected from the group consisting of Li₂S—P₂S₅, Li₂S—LiI—P₂S₅, Li₂S—P₂S₅—LiCl, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₆PS₅Cl, Li₁₀GeP₂S₁₂, Li₃PS₄, Li₇P₃S₁₁ and combinations thereof.

The solid electrolyte membrane may comprise a sulfide-based solid electrolyte having an argyrodite structure.

The positive electrode may contain a positive electrode active material and a solid electrolyte.

The carbon material may comprise one selected from the group consisting of graphite, graphene, carbon black, carbon nanotubes, carbon fibers, activated carbon, and combinations thereof.

The binder may comprise one selected from the group consisting of poly(vinyl acetate), polyvinyl alcohol, polyethylene oxide, polyvinylpyrrolidone, alkylated polyethylene oxide, crosslinked polyethylene oxide, polyvinyl ether, poly(methyl methacrylate), polyvinylidene fluoride (PVDF), a copolymer of polyhexafluoropropylene and polyvinylidene fluoride, poly(ethylacrylate), polytetrafluoroethylene, polyvinylchloride, polyacrylonitrile, polyvinylpyridine, polystyrene, styrene-butadiene rubber (SBR), carboxymethyl cellulose (CMC) and combinations thereof.

According to the present disclosure, since a plurality of composite carbon layers with different contents of binder are included between the negative electrode and the solid electrolyte membrane of the all-solid-state battery, the composite carbon layer disposed adjacent to the solid electrolyte membrane has high elasticity and acts as a protective layer within the battery and thus can improve the physical and mechanical stability of the all-solid-state battery, and can prevent damage to the solid electrolyte membrane due to the volume change of the battery that occurs during charging/discharging and can increase the interfacial stability with the negative electrode, and the composite carbon layer, which has a relatively small content of binder, induces lithium diffusion in the plane direction to prevent precipitation of lithium dendrite, and as a result, has the effect of improving the lifetime characteristics of the all-solid-state battery.

### BRIEF DESCRIPTION OF DRAWINGS

FIG. 1 shows a schematic cross-sectional view of the all-solid-state battery according to an example of the present disclosure.

FIG. 2 is a graph showing lifetime characteristics of all-solid-state batteries according to an example and comparative examples of the present disclosure.

### DETAILED DESCRIPTION

Hereinafter, embodiments of the present disclosure will be described in detail. Prior to this, the terms and words used in the present specification and claims should not be construed as limited to ordinary or dictionary terms, and should be construed in a sense and concept consistent with the technical idea of the present disclosure, based on the principle that the inventor can properly define the concept of a term to describe his invention in the best way possible. Therefore, since the configuration shown in the embodiments and drawings described in the present specification is only one of the most preferred embodiments of the present disclosure, and does not represent all of the technical spirit of the present disclosure, it should be understood that various equivalents and modifications may be substituted for them at the time of filing the present application.

Throughout the present specification, when a certain part ‘includes’ a certain component, it means that it may further include other components without excluding other components unless otherwise stated.

In order to clearly express the various layers and regions in the drawing, the thickness is enlarged and shown, and when a part such as a layer, film, region, plate, etc. is said to be “on” the other part, this includes not only the case where it is “directly on” the other part, but also the case where there is another part in between. Conversely, when the part is said to be “directly on” the other part, it means that there is no other part in between.

Hereinafter, an all-solid-state battery according to an example will be described.

The present disclosure relates to an all-solid-state battery that prevents the generation of lithium dendrite and has improved physical stability and lifetime characteristics.

In general, an all-solid-state battery using a solid electrolyte can increase the safety of the battery and prevent leakage of the electrolyte solution, thereby improving the reliability of the battery. However, in such an all-solid-state battery, when charging/discharging is repeated, a phenomenon that is not uniformly plated on the lithium metal negative electrode occurs. Accordingly, there is a problem that lithium dendrite can be generated on the lithium metal negative electrode, which can cause a short circuit in the cell, and the solid electrolyte membrane can be damaged due to the volume change of the battery that occurs during charging/discharging.

In contrast, in order to solve the above problems, the present disclosure applies a plurality of composite carbon layers having different contents of binder to the negative electrode of the all-solid-state battery, and thus the composite carbon layer disposed adjacent to the solid electrolyte membrane has high elasticity and acts as a protective layer within the battery and thus can improve the physical and mechanical stability of the all-solid-state battery, and can prevent damage to the solid electrolyte membrane due to the volume change of the battery that occurs during charging/discharging and can increase the interfacial stability with the negative electrode, and the composite carbon layer, which has a relatively small content of binder, induces lithium diffusion in the plane direction to prevent precipitation of lithium dendrite, and as a result, has the effect of improving the lifetime characteristics of the all-solid-state battery.

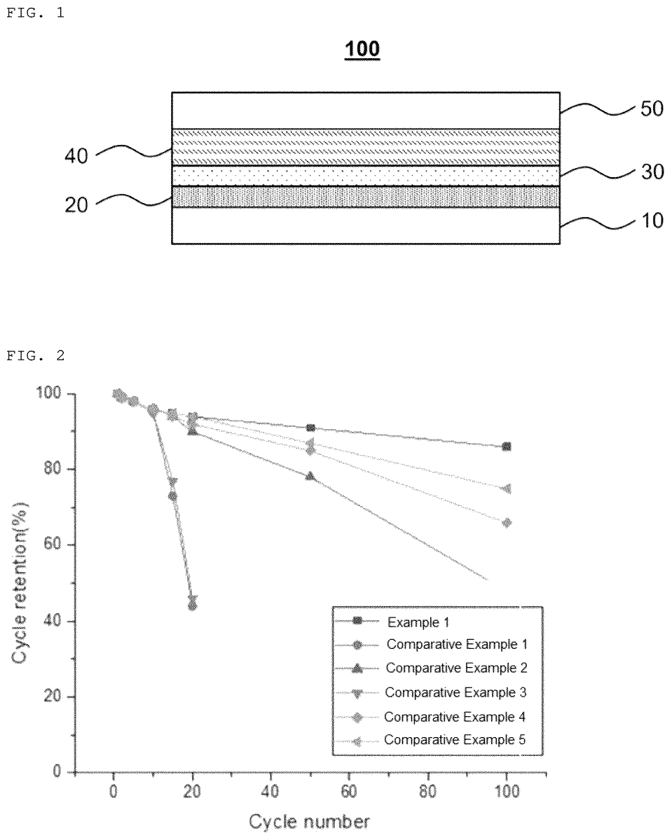

FIG. 1 is a cross-sectional view showing a schematic configuration of an all-solid-state battery according to one embodiment.

Referring to FIG. 1, the all-solid-state battery 100 according to one embodiment comprises a positive electrode 50, a negative electrode 10, and a solid electrolyte membrane 40 between the positive electrode and the negative electrode and comprises a second composite carbon layer 20 and a first composite carbon layer 30 between the solid electrolyte membrane and the negative electrode.

The second composite carbon layer 20 and the first composite carbon layer 30 will be described later in more detail.

The positive electrode may comprise a current collector and a positive electrode active material layer formed on at least one side of the current collector, and the positive electrode active material layer may contain a positive electrode active material, a solid electrolyte, and an electrically conductive material. In addition, in one specific embodiment of the present disclosure, the positive electrode active material layer may further contain a binder material. The addition of the binder material can increase the binding force between the positive electrode active material layer and the current collector and/or the solid electrolyte layers, and independently or together with this, it helps to improve the binding force between the components contained in the positive electrode active material.

The positive electrode active material can be used without limitation as long as it can be used as the positive electrode active material of a lithium-ion secondary battery. For example, the positive electrode active material may comprise layered compounds such as lithium cobalt oxide (LiCoO₂) and lithium nickel oxide (LiNiO₂) or compounds substituted with one or more transition metals; lithium manganese oxides such as formulas Li₁₊ₓMn₂₋ₓO₄ (wherein x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; lithium nickel oxide represented by formula LiNi₁₋ₓMₓO₂ (wherein M=Co, Mn, Al, Cu, Fe, Mg, B or Ga, and contains one or more of the above elements, x=0.01 to 0.3), for example, LiN_{0.8}Co_{0.1}M_{0.1}O₂; lithium manganese composite oxide represented by formula LiMn₂₋ₓMₓO₂ (wherein M=Co, Ni, Fe, Cr, Zn or Ta, x=0.01 to 0.1) or Li₂Mn₃MO₈ (wherein M=Fe, Co, Ni, Cu or Zn); lithium manganese composite oxide with spinel structure represented by LiNiₓMn₂₋ₓO₄; LiMn₂O₄ in which a part of Li in the formula is replaced with an alkaline earth metal ion; disulfide compounds; Fe₂(MoO₄)₃ and the like. However, it is not limited only to these. The positive electrode active material may be contained in an amount ranging from 70 to 95% by weight, 75 to 95% by weight, or 80 to 95% by weight, based on 100% by weight of the electrode layer.

The solid electrolyte contained in the positive electrode may comprise, for example, one selected from the group consisting of Li₂S—P₂S₅, Li₂S—LiI—P₂S₅, Li₂S—P₂S₅—LiCl, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₆PS₅Cl, Li₁₀GeP₂S₁₂, Li₃PS₄, Li₇P₃S₁₁ and combinations thereof, and preferably may comprise Li₆PS₅Cl, which is a sulfide-based solid electrolyte having an argyrodite structure. The solid electrolyte may be contained in an amount ranging from 1 to 30% by weight, 1 to 20% by weight, or 1 to 15% by weight, based on 100% by weight of the electrode layer.

The electrically conductive material is not particularly limited as long as it has electrical conductivity without causing chemical changes in the relevant battery, and for example, may comprise one or a mixture of two or more selected from graphite such as natural graphite or artificial graphite; carbon blacks such as carbon black, acetylene black, Ketjen black, channel black, furnace black, lamp black, and thermal black; electrically conductive fibers such as carbon fibers such as vapor grown carbon fiber (VGCF) or metal fibers; metal powders such as carbon fluoride, aluminum and nickel powder; electrically conductive whiskers such as zinc oxide and potassium titanate; electrically conductive metal oxides such as titanium oxide; electrically conductive materials such as polyphenylene derivative. The electrically conductive material may be contained in an amount ranging from 1 to 10% by weight, or 1 to 5% by weight, based on 100% by weight of the electrode layer.

The binder is not particularly limited as long as it is a component that assists in bonding the active material and the electrically conductive material and bonding to the current collector, and for example, may comprise polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber (SBR), fluoro rubber, various copolymers and the like. The binder may be typically contained in an amount ranging from 1 to 20% by weight or 1 to 10% by weight based on 100% by weight of the electrode layer.

The negative electrode may be a negative electrode current collector or may include a negative electrode active material layer formed on a surface of the current collector.

The negative electrode current collector is not particularly limited as long as it has conductivity without causing chemical change in the all-solid-state battery, and for example, may comprise copper, stainless steel, nickel, titanium, sintered carbon, or copper, or stainless steel surface-treated with carbon, nickel, titanium, silver or the like. In addition, the negative electrode current collector may be used in various forms such as a film, a sheet, a foil, a net, a porous body, a foam, and a non-woven fabric having fine irregularities formed on their surfaces, as in the positive electrode current collector.

In one embodiment of the present disclosure, the negative electrode and/or the positive electrode may further include various additives for the purpose of supplementing or improving physicochemical properties. The additives are not particularly limited, but may include one or more additives such as oxidation stability additives, reduction stability additives, flame retardants, heat stabilizers, and antifogging agents.

The negative electrode and the positive electrode may be prepared by using cyclic aliphatic hydrocarbons such as cyclopentane, cyclohexane or mixtures thereof, aromatic hydrocarbons such as toluene, xylene or mixtures thereof, or aliphatic hydrocarbons and aromatic hydrocarbons alone or in combination of two or more as organic solvents when preparing a slurry for the electrodes, respectively. The organic solvent may be appropriately selected and used according to drying speed or environmental conditions.

The solid electrolyte membrane 40 is disposed between the negative electrode 10 and the positive electrode 50.

The solid electrolyte membrane may contain a solid electrolyte and a binder.

The solid electrolyte contained in the positive electrode may comprise, for example, one selected from the group consisting of Li₂S—P₂S₅, Li₂S—LiI—P₂S₅, Li₂S—P₂S₅—LiCl, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₆PS₅Cl, Li₁₀GeP₂S₁₂, Li₃PS₄, Li₇P₃S₁₁ and combinations thereof. The solid electrolyte may be typically contained in an amount ranging from 80 to 100% by weight, 90 to 100% by weight, or 95 to 100% by weight based on 100% by weight of the solid electrolyte membrane.

The binder contained in the solid electrolyte membrane is not particularly limited as long as it is a component that assists in the binding of the solid electrolyte, and for example, may comprise polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber (SBR), fluoro rubber, various copolymers and the like. The binder may be contained in an amount ranging from 1 to 20% by weight or 1 to 10% by weight based on 100% by weight of the solid electrolyte membrane.

The ionic conductivity of the solid electrolyte membrane may be, for example, in excess of 0.5×10⁻³ S/cm and less than or equal to 1×10⁻¹ S/cm. If the ionic conductivity of the solid electrolyte membrane is less than 0.5×10⁻³ S/cm, since lithium ion conduction between the positive electrode and the negative electrode within the structure of the all-solid-state battery cannot be provided as a main path, it is difficult to implement the basic performance of the cell. The higher the ionic conductivity of the solid electrolyte membrane, the more advantageous it is, but when comprehensively considering the characteristics of the solid electrolyte, limitations in performance implementation, atmospheric stability and the like, it is desirable to limit it to a range of 1×10⁻¹ S/cm or less.

In one embodiment, the all-solid-state battery further comprises a second composite carbon layer 20 and a first composite carbon layer 30 between the negative electrode 10 and the solid electrolyte membrane 40.

In one embodiment, the first composite carbon layer may be disposed adjacent to one surface of the solid electrolyte membrane, and the second composite carbon layer may be disposed adjacent to one surface of the negative electrode.

In one embodiment, the first composite carbon layer and the second composite carbon layer may contain a carbon material and a binder.

The carbon material may not be limited to the type as long as it can impart electrical conductivity to the first composite carbon layer and the second composite carbon layer, and for example, may comprise one selected from the group consisting of graphite, graphene, carbon black, carbon nanotubes, carbon fibers, activated carbon, and combinations thereof.

The binder may comprise, for example, one selected from the group consisting of poly(vinyl acetate), polyvinyl alcohol, polyethylene oxide, polyvinylpyrrolidone, alkylated polyethylene oxide, crosslinked polyethylene oxide, polyvinyl ether, poly(methyl methacrylate), polyvinylidene fluoride (PVDF), a copolymer of polyhexafluoropropylene and polyvinylidene fluoride, poly(ethylacrylate), polytetrafluoroethylene, polyvinylchloride, polyacrylonitrile, polyvinylpyridine, polystyrene, styrene-butadiene rubber (SBR), carboxymethyl cellulose (CMC) and combinations thereof, and preferably, may be polyvinylidene fluoride (PVDF).

In one embodiment, the content of the binder in the first composite carbon layer and the second composite carbon layer may be different from each other. Also, in one embodiment, the content of the binder in the second composite carbon layer may be lower than the content of the binder in the first composite carbon layer.

Specifically, the weight ratio of the carbon material to the binder in the first composite carbon layer may be 80:20 to 95:5, for example, 85:15 to 95:5, for example, 90:10.

The weight ratio of the carbon material to the binder in the second composite carbon layer may be 95:5 to 99:1, for example, 96:4 to 99:1, 97:3 to 99:1, or 98:2 to 99:1. If the content of carbon in the second composite carbon layer is less than 95 parts by weight relative to the total content of the carbon material and the binder, there may be a problem that electrical conductivity and ionic conductivity may be reduced, thereby resulting in relatively overvoltage.

In the all-solid-state battery according to the present disclosure, since the second composite carbon layer disposed adjacent to one surface of the negative electrode contains a relatively higher content of carbon material than the first composite carbon layer, lithium diffusion can be induced in the surface direction of the all-solid-state battery, not in the thickness direction, thereby preventing the precipitation of lithium dendrite, and thus improving the lifetime characteristics of the all-solid-state battery.

In addition, as the first composite carbon layer disposed adjacent to one surface of the solid electrolyte membrane contains a relatively higher content of binder than the second composite carbon layer, it has high elasticity and acts as a protective layer within the all-solid-state battery and thus can improve the physical and mechanical stability of the all-solid-state battery, can prevent damage to the solid electrolyte membrane due to the volume change of the battery that occurs during charging/discharging, and can increase the interfacial stability with the negative electrode.

In one example, the thickness ratio of the first composite carbon layer to the second composite carbon layer may be 20:1 to 1:1, preferably 10:1 to 2:1. Specifically, the thickness of the first composite carbon layer may be 5 μm to 20 μm, and the thickness of the second composite carbon layer may be 1 μm to 5 μm.

If the thickness of the first composite carbon layer is less than 5 μm, there may be a problem of not effectively separating Li precipitated during the operation of the battery and electrolyte. If the thickness of the first composite carbon layer exceeds 20 μm, as the thickness of the first composite carbon layer is relatively increased, there may be a problem that overvoltage may occur significantly.

The present disclosure provides a battery module comprising the all-solid-state battery as a unit cell, a battery pack comprising the battery module, and a device comprising the battery pack as a power source.

In this case, a specific example of the device may be a power tool powered by an electric motor; electric cars comprising an electric vehicle (EV), a hybrid electric vehicle (HEV), a plug-in hybrid electric vehicle (PHEV), and the like; an electric motorcycle comprising an electric bike (E-bike) and an electric scooter (E-scooter); an electric golf cart; and a power storage system, but is not limited thereto.

Hereinafter, specific examples of the present disclosure are presented. However, the examples described below are only for specifically illustrating or explaining the present disclosure, and the present disclosure is not limited thereto. In addition, the content not described herein can be sufficiently technically inferred by those skilled in the art, and thus the description thereof will be omitted.

### Example 1

### 1. Preparation of Slurry for Formation of Composite Carbon Layer

(1) The slurry for forming a first composite carbon layer was prepared in the following way.

Carbon black (Super P) as a carbon material and polyvinylidene fluoride (PVDF) as a binder at a ratio of 90:10 wt. % were mixed in the solvent N-Methylpyrrolidone (NMP) to prepare a slurry.

(2) A slurry for forming a second composite carbon layer was prepared in the same manner as the slurry for forming the first composite carbon layer, except that carbon black (Super P) as a carbon material and polyvinylidene fluoride (PVDF) as a binder are mixed in an amount of 95:5 wt. %.

### 2. Manufacture of Positive Electrode

For the preparation of the slurry, LiCoO₂ powder as a positive electrode active material, an argyrodite structured crystalline sulfide solid electrolyte Li₆PS₅Cl as a solid electrolyte, Super C65 from Timcal Company as an electrically conductive material and styrene butadiene rubber (SBR) as a binder were mixed in a weight ratio of 80:15:1:4, respectively, and put into xylene and stirred to prepare a slurry for the positive electrode, This was applied to an aluminum current collector with a thickness of 20 μm using a doctor blade, and the resulting product was vacuum dried at 120° C. for 4 hours. Thereafter, the product obtained by vacuum drying was subjected to a rolling process using cold iso pressure (CIP) to obtain a positive electrode having an electrode loading of 4 mAh/cm², an electrode layer thickness of 128 μm and a porosity of 15%.

### 3. Manufacture of Solid Electrolyte Membrane

Li₆PS₅Cl powder as a crystalline sulfide solid electrolyte and styrene-butadiene rubber (SBR) as a binder were mixed at 95:5 wt % in xylene as a solvent to prepare a slurry. To the release film, the mixed slurry was applied and coated using a doctor blade. The coating gap was 250 μm and the coating speed was 20 mm/min. The release film coated with the slurry was moved to a glass plate, and then held horizontally, dried overnight at room temperature, and vacuum dried at 100° C. for 12 hours. The thickness of the obtained solid electrolyte membrane was 100 μm.

### 4. Manufacture of Battery

(1) The positive electrode prepared above was punched into a square of 4 cm². A Ni foil with a square size of 6.25 cm² was prepared as a negative electrode current collector, and the slurry for the formation of the second composite carbon layer prepared above was applied onto the Ni foil, and the resultant was vacuum-dried at 120° C. for 4 hours to form a second composite carbon layer with a thickness of 5 μm on one surface of the negative electrode current collector.

(2) Next, the slurry for the formation of the first composite carbon layer prepared above is applied to one surface of the release film, the resultant is vacuum-dried at 120° C. for 4 hours, prepared in a square size of 6.25 cm², and then the first composite carbon layer was attached to one surface of the solid electrolyte membrane to be a thickness of 10 μm using Cold Isostatic Pressing (CIP).

(3) A solid electrolyte membrane is disposed between the positive electrode and the negative electrode to manufacture a mono-cell (half-cell). In this case, the second composite carbon layer coated on the negative electrode current collector and the first composite carbon layer coated on the solid electrolyte membrane were disposed to contact each other, and the cells were combined in a CIP process to manufacture an all-solid battery.

### Comparative Example 1

An all-solid-state battery was manufactured in the same manner as in Example 1 above, except that the first composite carbon layer and the second composite carbon layer are not formed on the negative electrode and the solid electrolyte membrane, respectively.

### Comparative Example 2

An all-solid-state battery was manufactured in the same manner as in Example 1 above, except that in Example 1 above, the second composite carbon layer is not formed.

### Comparative Example 3

An all-solid-state battery was manufactured in the same manner as in Example 1 above, except that in Example 1 above, the first composite carbon layer is not formed.

### Comparative Example 4

An all-solid-state battery was manufactured in the same manner as in Example 1 above, except that in Example 1 above, the thickness of the first composite carbon layer is 3 μm.

### Comparative Example 5

An all-solid-state battery was manufactured in the same manner as in Example 1 above, except that in Example 1 above, a mixture of carbon black (Super P) and polyvinylidene fluoride (PVDF) at a ratio of 90:10 wt. % was used as a slurry for forming a second composite carbon layer, and a mixture of carbon black (Super P) and polyvinylidene fluoride (PVDF) at a ratio of 95:5 wt. % is used as a slurry for forming the first composite carbon layer.

### Experimental Example 1: Evaluation of Performance of Battery

Energy density was evaluated depending on the number of times (cycles) of charging/discharging of the all-solid-state batteries manufactured in Example 1 and Comparative Examples 1 to 5, and the results are shown in FIG. 2.

Referring to FIG. 2, it can be confirmed that in the case of the all-solid-state battery according to Example 1, a higher capacity retention rate of about 90% or more is shown even after about 100 charging/discharging cycles than in the case of the all-solid-state battery according to Comparative Examples 1 to 5, and thus it represents the best lifetime characteristics. In particular, it can be seen that the all-solid-state battery according to Example 1 shows a high-capacity retention rate of more than 96% at about 10 times of charging/discharging compared to the initial period.

In contrast, it can be seen that in the case of the all-solid-state battery according to Comparative Example 1 in which neither the first composite carbon layer nor the second composite carbon layer is provided, or the all-solid-state battery according to Comparative Example 3 in which the first composite carbon layer is not provided, the capacity retention rate is rapidly decreased compared to the initial capacity from about 10 times of charging/discharging.

In addition, it can be seen that in all the cases of the all-solid-state battery according to Comparative Example 2 in which the second composite carbon layer is not provided, the all-solid-state battery according to Comparative Example 4 in which the thickness range of the first composite carbon layer is relatively thin, and the all-solid-state battery according to Comparative Example 5 in which the binder contents in the first composite carbon layer and the second composite carbon layer are reversed, the capacity retention rates are significantly reduced compared to the all-solid-state battery according to Example 1.

Although the preferred examples of the present disclosure have been described in detail above, the scope of the present disclosure is not limited thereto, and various modifications and improvements made by those skilled in the art using the basic concepts of the present disclosure defined in the following claims also fall within the scope of the present disclosure.

### DESCRIPTION OF REFERENCE NUMERALS

10: Negative electrode
20: Second composite carbon layer
30: First composite carbon layer
40: Solid electrolyte membrane
50: Positive electrode
100: All-solid-state battery

1. An all-solid-state battery; comprising:
a positive electrode;
a negative electrode; and
a solid electrolyte membrane between the positive electrode and the negative electrode,
wherein the all-solid-state battery further comprises a first composite carbon layer and a second composite carbon layer between the negative electrode and the solid electrolyte membrane.

2. The all-solid-state battery according to claim 1, wherein the first composite carbon layer is disposed adjacent to one surface of the solid electrolyte membrane, and the second composite carbon layer is disposed adjacent to one surface of the negative electrode.

3. The all-solid-state battery according to claim 1, wherein each of the first composite carbon layer and the second composite carbon layer contains a carbon material and a binder, and
wherein a content of the binder in the first composite carbon layer and a content of the binder in the second composite carbon layer are different from each other.

4. The all-solid-state battery according to claim 3, wherein a weight ratio of the carbon material to the binder in the first composite carbon layer is 80:20 to 95:5, and a weight ratio of the carbon material to the binder in the second composite carbon layer is 95:5 to 99:1.

5. The all-solid-state battery according to claim 1, wherein a thickness ratio of the first composite carbon layer to the second composite carbon layer is from 20:1 to 1:1.

6. The all-solid-state battery according to claim 1, wherein a thickness of the first composite carbon layer is 5 to 20 μm, and a thickness of the second composite carbon layer is 1 to 5 μm.

7. The all-solid-state battery according to claim 1, wherein the solid electrolyte membrane is any one selected from the group consisting of Li₂S—P₂S₅, Li₂S—LiI—P₂S₅, Li₂S—P₂S₅—LiCl, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, and Li₂S—GeS₂—ZnS, Li₆PS₅Cl, Li₁₀GeP₂S₁₂, Li₃PS₄, Li₇P₃S₁₁ and combinations thereof.

8. The all-solid-state battery according to claim 1, wherein the solid electrolyte membrane comprises a sulfide-based solid electrolyte of an argyrodite structure.

9. The all-solid-state battery according to claim 1, wherein the positive electrode comprises a positive electrode active material and a solid electrolyte.

10. The all-solid-state battery according to claim 3, wherein the carbon material includes one selected from the group consisting of graphite, graphene, carbon black, carbon nanotubes, carbon fibers, activated carbon, and combinations thereof.

11. The all-solid-state battery according to claim 3, wherein the binder is one selected from the group consisting of poly(vinyl acetate), polyvinyl alcohol, polyethylene oxide, polyvinylpyrrolidone, alkylated polyethylene oxide, crosslinked polyethylene oxide, polyvinyl ether, poly(methyl methacrylate), polyvinylidene fluoride (PVDF), a copolymer of polyhexafluoropropylene and polyvinylidene fluoride, poly(ethylacrylate), polytetrafluoroethylene, polyvinylchloride, polyacrylonitrile, polyvinylpyridine, polystyrene, styrene-butadiene rubber (SBR), carboxymethyl cellulose (CMC) and combinations thereof.
